(19) United States
(12) Patent Application Publication
(10) Pub. No.: US 2023/0385717 A1
(43) Pub. Date: Nov. 30, 2023

(54) Artificial Intelligence-powered Tour Booking System

(71) Applicants: Kenneth Eade, Monaco (MC); Vyacheslav Shirokov, Tas-Sliema (MT)

(72) Inventors: Kenneth Eade, Monaco (MC); Vyacheslav Shirokov, Tas-Sliema (MT)

(21) Appl. No.: 18/233,912

(22) Filed: Aug. 15, 2023

(51) Int. Cl. G06Q 10/02; G06Q 30/0601; G06Q 50/14

(52) U.S. Cl. CPC G06Q 10/025; G06Q 30/0631; G06Q 50/14

(57) ABSTRACT

The invention disclosed herein introduces an innovative Artificial Intelligence-powered Tour Booking System, designed to revolutionize the tour booking experience within the travel and tourism industry. Departing from conventional methods, this system seamlessly combines advanced technologies to offer travelers a comprehensive and personalized solution. It comprises a travel database encompassing an extensive range of tour options, a recommendation engine fueled by AI algorithms, a booking engine that autonomously interfaces with travel service providers, and an intuitive user interface facilitating user-system interactions.

The recommendation engine, a pinnacle of AI sophistication, taps into user preferences, historical data, and online behaviors to provide tailored tour suggestions. By fusing these insights, the engine serves up tour options that uniquely match individual preferences and constraints, transcending the limitations of generic recommendations. In a groundbreaking move, the booking engine automates the booking process, engaging with tour operators, hotels, airlines, and transportation services to secure reservations based on user selections. This automation streamlines the user experience, mitigating manual errors and minimizing time investment.

The user interface further elevates the invention by delivering a user-friendly platform for seamless interaction. This interface empowers users to input preferences, access personalized recommendations, review itinerary proposals, and make selections in alignment with their travel desires. Collectively, these components culminate in an ecosystem that reshapes tour booking, providing users with a holistic, efficient, and personalized approach to discovering and booking their dream tours. This innovation stands at the forefront of AI-driven advancements, offering travelers unprecedented convenience and enriching their journey through the realm of travel and exploration.

### FIELD OF THE INVENTION

The field of the invention is travel and tourism, specifically focusing on the tour booking process.

### BACKGROUND

The field of travel and tourism has undergone a transformation with the advent of technology, and particularly, artificial intelligence. Prior art in this field includes various online travel agencies and tour booking platforms that provide users with the ability to search for and book tours. These platforms, however, often rely on basic search filters and limited user inputs, resulting in recommendations that might not precisely match the traveler's preferences and constraints. Additionally, traditional tour booking systems lacked the ability to make bookings automatically on behalf of the traveler, necessitating manual intervention.

The emergence of AI-powered recommendation systems in various domains has influenced the travel industry. AI algorithms have been used to analyze user behavior, preferences, and historical data to provide personalized suggestions. However, prior art in this domain generally lacked the depth and integration necessary to offer a seamless end-to-end tour booking experience. Furthermore, the integration of AI with tour operators' booking systems to enable automated tour booking is an advancement beyond previous solutions.

### SUMMARY OF THE INVENTION AND ITS COMPONENTS

The present invention, an Artificial Intelligence-powered Tour Booking System, bridges the gap between traditional tour booking methods and the capabilities of modern AI technology. This innovation utilizes advanced AI algorithms to enhance the tour booking process by tailoring recommendations to the unique preferences and constraints of each traveler.

The “Artificial Intelligence-powered Tour Booking System” is a pioneering invention that capitalizes on the advancements in AI technology to revolutionize the tour booking process. By addressing the limitations of prior art through personalized recommendations and automated booking capabilities, the invention offers a comprehensive solution that empowers travelers to effortlessly discover, tailor, and book their ideal tour experiences.

### THE KEY COMPONENTS OF THE INVENTION INCLUDE

Comprehensive Travel Database: The system is built upon a comprehensive database that encompasses a wide range of tour options, destinations, activities, accommodations, and transportation modes. This database serves as the foundation for the AI algorithms to generate precise recommendations.

AI-driven Personalization: The heart of the invention lies in the sophisticated AI algorithms. These algorithms analyze a traveler's input, historical data, online behavior, and other relevant factors to understand their preferences. By employing machine learning techniques, the system adapts and refines its recommendations over time, ensuring an increasingly accurate personalized experience.

Automated Booking Interface: A pivotal feature is the system's integration with the booking systems of tour operators, hotels, airlines, and transportation services. Unlike prior art that primarily focused on recommendations, this invention extends its capabilities by autonomously executing bookings based on the traveler's choices. This streamlines the booking process, saving travelers time and reducing the risk of errors associated with manual bookings.

Tour Components: The tours that can be booked through the system encompass various components, such as:
Tour Guides: The system can suggest tours led by knowledgeable and certified guides who enhance the traveler's experience by providing insights and context.
Transfers: The invention can recommend seamless transportation arrangements between destinations, ensuring a smooth transition for the traveler.
Accommodations (Hotels): Based on preferences, the system can recommend hotels that align with the traveler's comfort and budget requirements.
Air and Ground Transportation: The system considers available flights, trains, buses, and other modes of transportation, optimizing the traveler's itinerary.
Other Travel Tour Features: The invention extends to recommending activities, excursions, dining options, and other experiences that augment the tour.

1. An AI-powered tour booking system, comprising:
This invention pertains to an AI-powered tour booking system that amalgamates a series of distinct but interconnected components, creating a seamless ecosystem for travelers to explore, personalize, and book tours that cater to their preferences and constraints. The invention consists of the following essential components:
Travel Database: A comprehensive repository of tour options, destinations, accommodations, transportation modes, and activities forms the backbone of the AI-powered system. This dynamic database encompasses a myriad of options, ranging from cultural excursions to adventure tours, ensuring a diverse array of choices for users.
Recommendation Engine: The core intelligence of the system resides within the recommendation engine, a sophisticated AI algorithm that thrives on the integration of user input, historical data, and online behavior. By analyzing this wealth of information, the recommendation engine tailors tour recommendations to each user's unique profile, offering tours that resonate with their preferences and constraints.
Booking Engine: In addition to recommendations, the system boasts a booking engine that excels at automating the tour booking process. This component interacts seamlessly with the booking systems of various travel service providers, such as tour operators, hotels, airlines, and ground transportation services. By interfacing with these providers, the booking engine orchestrates the booking process based on the user's selections, eliminating the need for manual intervention.
User Interface: To facilitate user engagement, the invention encompasses a user-friendly interface. This interface serves as the conduit through which users can interact with the system, input their preferences and constraints, review personalized recommendations, and make selections for their desired tour components.

2. The recommendation engine of the system is configured to recommend tours to a user based on the user's preferences and constraints.
The AI-powered tour booking system goes beyond mere suggestions by harnessing the potential of AI-driven recommendation engines. By collecting and analyzing data from multiple sources, including user-provided inputs and historical behavior, the recommendation engine is finely tuned to discern a user's preferences and constraints. This enables the system to suggest tours that align with the user's interests, budget, travel dates, and any other relevant parameters. Through this personalized approach, the recommendation engine enhances the user's experience, ensuring that the tours suggested are both appealing and tailored to their unique travel aspirations.

3. The booking engine of the system is configured to book tours on behalf of the user.
A distinctive facet of this invention lies in its autonomous booking capabilities. The booking engine functions as an intermediary between the user and travel service providers, eliminating the manual effort traditionally required for tour bookings. Once the user selects their preferred tour components, such as accommodations, activities, transportation modes, and more, the booking engine seamlessly interfaces with the booking systems of relevant providers to secure reservations. This automation not only saves the user time and effort but also minimizes the potential for errors associated with manual booking processes.

4. The user interface of the system is configured to allow the user to interact with the system.
Central to the user experience is the intuitive and accessible user interface provided by the system. Designed with user engagement in mind, the interface offers a user-friendly platform through which travelers can effortlessly engage with the AI-powered capabilities of the system. Users can input their preferences, constraints, and other relevant details, receive personalized tour recommendations, review proposed itineraries, and make selections that resonate with their travel aspirations. Through this interface, the system bridges the gap between complex AI algorithms and the end-user, ensuring a smooth and interactive journey in discovering and booking their ideal tours.
